(19) United States
(12) Patent Application Publication
(10) Pub. No.: US 2007/0036938 A1
(43) Pub. Date: Feb. 15, 2007

(54) Pillar protection assembly

(75) Inventor: Don Stephan Engelbrecht, Amsterdam (NL)

Correspondence Address: YOUNG & THOMPSON, 745 SOUTH 23RD STREET, 2ND FLOOR, ARLINGTON, VA, 22202, US

(73) Assignee: Cornelis Van Den Donker, Swifterbant (NL)

(21) Appl. No.: 10/551,421

(22) PCT Filed: Mar. 31, 2004
(86) PCT No.: PCT/NL04/00217

§ 371 Date: Sep. 30, 2005

(30) Foreign Application Priority Data
Mar. 31, 2003 (NL) 1023057

(51) Int. Cl. B32B 3/06; B32B 3/04; E04C 3/30

(52) U.S. Cl. 428/99; 428/122; 52/736.4

(57) ABSTRACT

Pillar protection assembly (1) consisting of a plastic sleeve (7) inside which a number of plastic foam blanket sections (6) are arranged. The sleeve (7) can be provided with information on the outside and has a closure (8) so as to fix this to the pillar (5) after it has been wrapped around the latter. The plastic foam material of the plastic foam blanket (6) consists of a foam matrix in which particles are incorporated that preferably consist of a recycled material. The plastic foam material used can be polyether or polyurethane.

The present invention relates to a pillar protection assembly comprising a plastic foam blanket, which can be fitted around a pillar, as well as a plastic sleeve fitted around said blanket, wherein said plastic foam has a foam matrix in which particles differing from the matrix with a particle size of between 0.1 and 10 mm are incorporated.

A pillar protection assembly of this type is disclosed in DE 20116169 U1. In this publication a jacket made of recycled material in which granulate particles are incorporated is described.

In GB 2 209 041 A1 a protection to be fitted around a round pillar is described, consisting of an inner layer of foam material and an outer layer to which information can be applied.

The application for the protection described in this publication appears to be in schools, clubs and the like.

The aim of the present invention is to provide a pillar protection assembly that can be used to protect cars and is easy to fit. More particularly, the aim is to provide a pillar protection assembly that can be used in car parks or in other locations where cars have to be manoeuvred accurately and where it is a regular occurrence that cars scrape against concrete pillars and the like, as a result of which such vehicles can be damaged.

It has been found that conventional foam materials are not suitable for, on the one hand, offering adequate protection to the cars and, on the other hand, being able to be fitted in a reasonable size around the pillar in an optically correct manner.

The aim of the present invention is to provide a pillar protection assembly that does not have these disadvantages and is easy to fit on pillars of any shape.

This aim is realised with a pillar protection assembly as described above in that said foam blanket comprises a number of sections a distance (a) apart joined by a strip material.

By providing a gap it is possible in a simple manner to fit the plastic foam blanket around pillars, no creases and/or compressed portions being produced as a result of the difference in the length of the periphery between the inside of the foam blanket wound around the pillar and the outside thereof. This applies both for fitting of both round pillars and pillars of other shapes.

The mutual spacing between the sections of the foam blanket can be achieved by locally fitted strips. However, it is also possible to start from a continuous web of material, foam blanket sections being applied regular distances apart.

The present invention is in particular applicable to polygonal and more particularly square or rectangular pillars. In order to achieve correct positioning of the pillar protection assembly around the pilar it is proposed according to the present invention to build up the blanket from a number of blanket sections that are arranged spaced apart on the sleeve (unfolded). The distance between the sections corresponds to the thickness of the foam material. In this way accurate taut fitting around a pillar can be achieved. Preferably, the sleeve is supplied in the unfolded state and there are closure means to close the sleeve after wrapping it around a pillar. Such closure means can comprise a zip but can also comprise other known closure means. There is optionally a lock or the like to ensure that unauthorised persons are not able to remove the pillar protection assembly without substantial damage.

Polyether and polyurethane are mentioned as examples of the plastic foam used for the matrix. A relatively high density of the material is important for the present invention. An appreciable impact strength is also important. According to the present invention this is preferably between 5-250 kPa according to DIN 53571.

The material must preferably also have a residual compressive deformation after 90% deformation of 1-20% according to DIN 53572.

It has been found that if materials with such properties are used the motorist can immediately recognise if he touches the pillar protection assembly but, on the other hand, damage to the vehicle is prevented.

According to an advantageous embodiment of the invention, an auxiliary sleeve is fitted around the sleeve. Such an auxiliary sleeve can easily be removed and can bear information that can be changed. As a result it is possible, starting from a basic pillar protection assembly, to fit notices around it that change as desired.

The subject invention will be explained in more detail below with reference to an illustrative embodiment shown in the drawing. In the drawing:

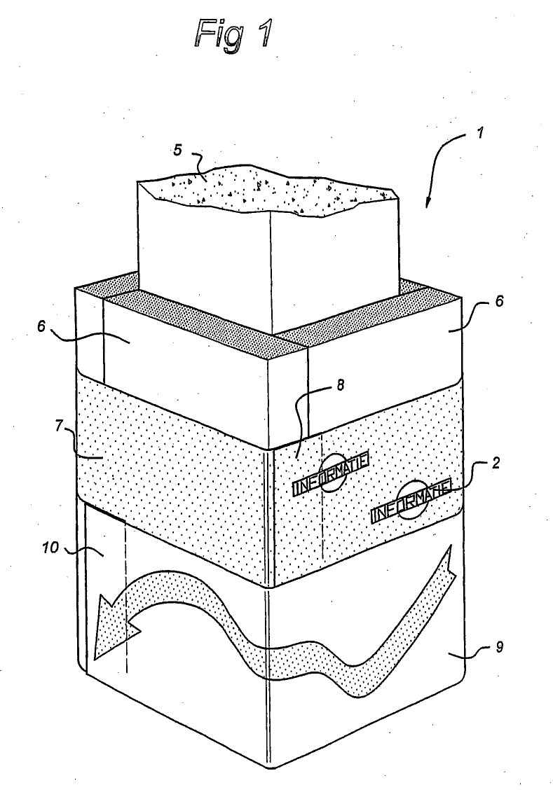

FIG. 1 shows the use of a pillar protection assembly according to the invention;

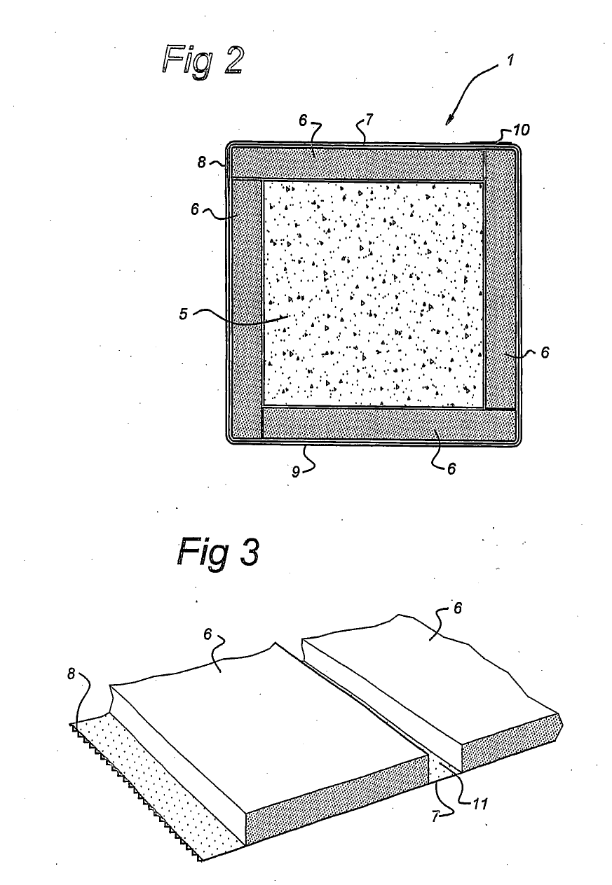

FIG. 2 shows a cross-section through a pillar provided with the protection assembly according to the invention;

FIG. 3 shows part of the pillar protection assembly according to the invention in the unfolded state; and

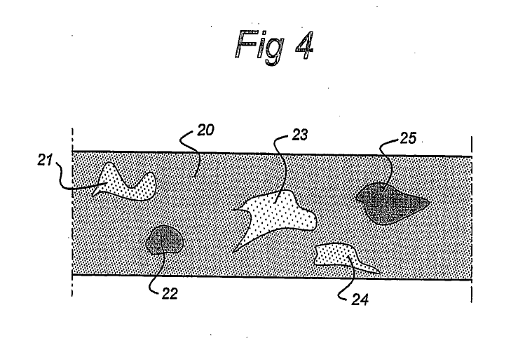

FIG. 4 shows a cross-section of the foam material used.

In FIG. 1 a pillar protection assembly is indicated by 1. This is provided with information 2. This can be used in car parks or in other locations where contact of moving objects with a stationary concrete pillar is not desired.

It can be seen from FIG. 2 that such a pillar of a multi-storey car park is indicated by 5. This is essentially of rectangular construction. The pillar protection assembly 1 according to the invention has been fitted around it. This consists, as can be seen in conjunction with FIG. 3, of a number of sheets of foam material 6 that have been applied with a spacing 11 to a piece of sailcloth material 7. Only one end of the sailcloth material 7 is indicated and this is provided with a zip 8. The corresponding part of the zip 8 is on the other end of the sailcloth material. The spacing 11 corresponds to the thickness of the sheets of foam material so that a taut rectangular construction can be obtained when the pillar protection assembly according to FIG. 3 is wrapped around a pillar. This can be seen, inter alia, from FIGS. 1 and 2.

The zip 8 can be provided with a fitting for a lock or the like to prevent removal by unauthorised persons.

It is also possible to fit an easily replaceable separate further sailcloth section 9 (auxiliary sleeve), which can likewise be closed by means of a closure such as zip 10, around the sailcloth section 7. As a result it is possible temporarily to provide other (advertising) information around the pillar assembly.

As indicated above, the material that faces outwards preferably consists of sailcloth material that is not very susceptible to soiling and is easy to clean. The material can optionally be treated, such as with Aquaseal, as a result of which a closed structure is obtained that does not pick up dirt easily.

According to the present invention the foam material preferably consists of recycled material that offers relatively high resistance to compression. Such a foam material is shown diagrammatically in FIG. 4 and consists of a matrix 20 in which particles 21-25 are incorporated. According to the present invention the matrix preferably consists of a foam material and more particularly of polyether or polyurethane material with relatively high relative density. At least the particles can consist of a recycled material and are preferably also foam particles. The particle size thereof is between 0.1-10 mm and more particularly between 1 and 7 mm.

The sailcloth material preferably consists of a fibre textile, such as of 100% polyester fibres, which has been plasticised on one or both sides with a layer of polyvinyl chloride. The relative density of such a cloth is preferably approximately 400-700 g/m³.

Both the cloth and the foam material are preferably made fire-retardant.

Variants that fall within the scope of the present invention and more particularly of the appended claims will be immediately apparent to those skilled in the art after reading the above description.

1-10. (canceled)

11. Pillar protection combination comprising a plastic foam blanket, which can be fitted around a pillar, as well as a plastic sleeve fitted around said blanket, wherein said plastic foam has a foam matrix in which particles differing from the matrix with a particle size of between 0.1 and 10 mm are incorporated, said foam blanket comprising a number of blanket sections a distance (a) apart joined by a strip material.

12. Pillar protection combination according to claim 11, wherein said particles are bonded to the matrix by a binder.

13. Pillar protection combination according to claim 11, wherein said particles comprise a recycled material.

14. Pillar protection combination according to claim 11, for the protection of a polygonal pillar, wherein the number of sections of said blanket corresponds to a number of surfaces of said pillar to be protected.

15. Pillar protection combination according to claim 11, wherein said distance is the thickness of the foam material.

16. Pillar protection combination according to claim 11, wherein said sleeve is provided with information on the outside.

17. Pillar protection combination according to claim 11, wherein said sleeve is split in the longitudinal direction and is provided with a closure.

18. Pillar protection combination according to claim 17, wherein said closure is a zip closure.

19. Pillar protection combination according to claim 11, wherein said sleeve comprises a sailcloth material.

20. Pillar protection combination according to claim 11, having an auxiliary sleeve provided with information to be fitted around said sleeve.
